(19) United States
(12) Patent Application Publication
(10) Pub. No.: US 2008/0309688 A1
(43) Pub. Date: Dec. 18, 2008

(54) Nanolithography with use of viewports

(75) Inventors: Jason Haaheim, Chicago, IL (US); Joseph S. Fragala, San Jose, CA (US); Raymond R. Shile, Los Gatos, CA (US)

Correspondence Address: FOLEY AND LARDNER LLP;SUITE 500, 3000 K STREET NW, WASHINGTON, DC, 20007, US

(73) Assignee: Nanolnk, Inc.

(21) Appl. No.: 12/073,909

(22) Filed: Mar. 11, 2008

Related U.S. Application Data
(60) Provisional application No. 60/894,657, filed on Mar. 13, 2007.

(51) Int. Cl. G01D 15/16

(52) U.S. Cl. 346/140.1

(57) ABSTRACT

Two dimensional arrays of cantilevers for use in transferring inks from the cantilever tip to substrates are improved with use of viewports to view the cantilevers from a far side. This improves the leveling behavior when large numbers of cantilevers are present. It also provides for better laser access. Bioarrays and combinatorial applications are particularly important. Massively parallel direct write printing with more than 55,000 cantilever tips can be achieved.

### RELATED APPLICATIONS

This application claims priority to U.S. provisional application Ser. No. 60/894,657 filed Mar. 13, 2007, which is hereby incorporated by reference in its entirety.

### BACKGROUND

Sharp tips and nanoscale tips can be used for high resolution patterning, wherein an ink or patterning compound can be transferred from the tip to a solid surface. For example, the tip can be an atomic force microscope (AFM) tip attached to one end of a cantilever. This direct write nanolithographic approach provides advantages which competing nanolithographies do not provide including high registration and reasonable costs. The cantilever can be used in several embodiments including for example: (i) a single cantilever, (ii) a linear array of cantilevers, and (iii) a two-dimensional array of cantilevers, e.g, multiple rows of linear arrays of cantilevers. See for example Mirkin et al, WO 00/41213, WO 01/91855, Small, 2005, 10, 940-945. See also U.S. Pat. Nos. 7,005,378; 7,034,854; 7,060,977; 7,098,056; and 7,102,656; to NanoInk.

A need exists to improve these methods, instruments, and devices, particularly as the cantilever embodiments become more complex in a two-dimensional system and as the processes are adapted to be commercial processes rather than academic studies. For example, as the cantilever arrays become more geometrically complex and larger with more and more cantilevers, leveling becomes more difficult. For example, if the method is not done properly, one tip may touch the surface before another second tip touches the surface, or the second tip may not even touch the surface. Or it may be difficult to know when the tips touch the surface. In many cases, it is desired that most or all of the tips are touching when writing, and most or all are off the surface when not writing. Cantilevers and tips can be damaged if not used properly.

### SUMMARY

Described herein are articles, apparatuses, instruments, devices, methods of making, and methods of using.

One embodiment provides an article comprising:

at least one support structure comprising a first side and an opposing second side, a two dimensional array of cantilevers supported by the support structure on the second side, wherein the support structure comprises at least one viewport adapted to allow viewing of the cantilevers from the first side.

Another embodiment provides an article comprising: a two-dimensional array of a plurality of cantilevers, wherein the array comprises a plurality of base rows, each base row comprising a plurality of cantilevers extending from the base row, wherein each of the cantilevers comprise tips at the cantilever end away from the base row; wherein the array is adapted to prevent substantial contact of non-tip components of the array when the tips are brought into contact with a substantially planar surface; and a support for the array, wherein the support comprises at least one viewport adapted to allow viewing of the cantilevers through the support.

Another embodiment provides a two-dimensional array of a plurality of cantilevers, the cantilevers comprising tips at the cantilever ends, wherein the array is adapted to prevent substantial contact of non-tip components of the array when the tips are brought into contact with a substantially planar surface, wherein the array is supported by a support structure which comprises at least one viewport for viewing the cantilevers.

Another embodiment provides a method comprising: (i) providing a first structure which comprises a support structure comprising a first side and a second opposing side, (ii) providing a second structure which comprises a two dimensional array of cantilevers, (iii) combining the first structure and the second structure, wherein the second structure is bonded to the second side of the first structure, and (iv) forming at least one viewport in the support structure so that cantilevers can be viewed from the first side of the support structure through the viewport.

Another embodiment provides a method comprising: (i) providing an instrument comprising at least one support structure comprising a first side and an opposing second side; a two dimensional array of cantilevers supported by the support structure on the second side; wherein the cantilevers comprise tips; wherein the support structure comprises at least one viewport adapted to allow viewing of the cantilevers from the first side; (ii) providing at least some of the cantilever tips with an ink composition; and (iii) transferring the ink composition from the tips to a substrate surface.

Another embodiment provides a method comprising: (i) providing an instrument comprising at least one support structure comprising a first side and an opposing second side; a two dimensional array of cantilevers supported by the support structure on the second side; wherein the support structure comprises at least one viewport adapted to allow viewing of the cantilevers from the first side; (ii) providing a structure which is to be imaged; and (iii) imaging the structure to be imaged with the instrument.

Another embodiment provides a method comprising: (i) providing at least one array of cantilevers supported by at least one support structure; (ii) providing a substrate; (iii) providing a plurality of viewports; and (iv) leveling the at least one array of cantilevers with respect to the substrate with the plurality of viewports, wherein the plurality of the viewports provide viewing of cantilevers.

Advantages among one or more of the various embodiments include better leveling of the pen array with respect to the surface, knowing when the pens are in contact with the surface, better providing of laser access to cantilevers to facilitate for example feedback, better protection of tips and cantilevers, better speed, better scalability, higher resolutions and registrations capability, and better seeing the surface to register to existing features on the nanoscale and microscale.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates a schematic of a direct-write nanolithographic process. For example, a molecule-coated AFM tip can be used to deposit an ink via a water meniscus onto a substrate.

FIG. 2 illustrates (A) an NSCRIPTOR™ DPN nanolithographic instrument (available, NanoInk, Chicago, Ill.), (B) screen capture of InkCad software showing nanoscale interdigitated line patterns, available NanoInk, (C) forward LFM image of interdigitated DPN line patterns of MHA written on mica-peeled gold. Line widths and pitches down to 20 nm can be observed, and placement precision better than 10 nm according to standard deviation measurements.

FIG. 3 illustrates patterning data from the 2D nano PrintArray showing a portion of the 55,000 replicas of the Jefferson Nickel. (Salaita et al., Angew. Chem. Int. Ed. 2006 45, 7220-7223.)

FIG. 4 illustrates an optical microscope image of a 2D nano print array (tips facing up) showing the pitch, spacing, and high yield. 832 individual tips are shown, roughly 1.5% of the entire array.

FIG. 5 illustrates a SEM image showing multiple rows of cantilevers attached to the silicon ridges depicted in FIG. 7. The inset shows individual cantilevers, while also highlighting the 7.5 micron tall tips and inherent cantilever curvature (about 6 degrees).

FIG. 6 illustrates high yield fabrication of pen arrays.

FIG. 7 illustrates important dimensions of 2D nano Print Arrays (not to scale).

FIG. 8 illustrates a (A) Top view schematic of the 2D nano PrintArray viewport configuration, as viewed through the Nscriptor scanner, (B) SEM top view image of the three central 2D nano PrintArray viewports.

FIG. 9 illustrates a (A) SEM top angled view of the etched viewports depicted in FIG. 5, (B) bottom view of three cantilevers in front of the viewport aperture, (C) with the device mounted on the Nscriptor scanner, one can see the cantilevers through the viewport both before the tips touch the gold surface, and (D) after. In FIGS. 9(C) and 9(D), one can observe a color shift. For example, FIG. 9(C) can be more pink in color, whereas FIG. 9(D) can be more green in color.

FIG. 10 illustrates a method of making the viewports.

FIG. 11 illustrates a portion of a finished device showing bonded cantilevers and viewport.

FIG. 12 illustrates cantilevers as seen through viewport from backside.

FIG. 13 illustrates an embodiment comprising standoffs and cantilever with tip.

FIG. 14 illustrates SEM images of the dimensions of the 2D nano PrintArray and freedom of travel (F.O.T.) relative to the standoffs for (A) a 2D nano PrintArray with a F.O.T. of 6 μm, and (B) a 2D nano PrintArray with a F.O.T of 19.5 μm as a result of an increase in curling.

FIG. 15 illustrates an embodiment, wherein the viewports are configured so that viewports 2a and 3a, 2b and 3b are aligned horizontally, respectively, to view the same row(s) of the cantilevers, permitting vertical alignments of the cantilevers on the same row.

FIG. 16 illustrates visual progression of the deflection of cantilevers with different F.O.T. observed in several viewports: (A) The sequence of positions of the z-piezoelectric sensor (“z-piezo”) used to bring the cantilevers into contact with the surface; (B) the highly curled cantilevers with a F.O.T. of 22.3 μm exhibited a color shift that was not dramatic, but these cantilevers noticeably lengthened as they contacted the surface and uncurled; (C) the cantilevers were slightly curled with a moderate F.O.T of 19.5 μm and displaying cantilever lengthening and a slight color shift; (D)(E) the cantilevers had a F.O.T. of 12.0 μm, but displayed a dramatic color shift across the entire length of the cantilever. There was a subtle color and shade change at the base of the cantilever (see inset), and the change became obvious as the z-piezo was repeatedly extended to 9.0 μm and retracted; it became even more pronounced at an extension of 13.7 μm; (F) in some embodiments, reflection on the angled sidewall of the viewport was observed. This occurred when the cantilever was very close to the viewport aperture, and can be an indicator that the cantilevers have been driven too far into the substrate.

FIG. 17 illustrates a schematic of the sidewall reflection phenomena, showing how the cantilevers reflect images of themselves on the viewport sidewalls when they become in close proximity with the viewport aperture.

FIG. 18 illustrates (A) a schematic of aperture-sidewall reflection phenomena for different deflection regimes, and (B) their respective optical images obtained from a viewport. The F.O.T. for these cantilevers was about 16.6 μm, and the progression of sidewall deflection became more overt as the cantilevers became more deflected.

### DETAILED DESCRIPTION

### Introduction

All references cited herein are hereby incorporated by reference in their entirety.

Priority U.S. provisional application Ser. No. 60/894,657 filed Mar. 13, 2007 is hereby incorporated by reference in its entirety including claims, figures, and drawings.

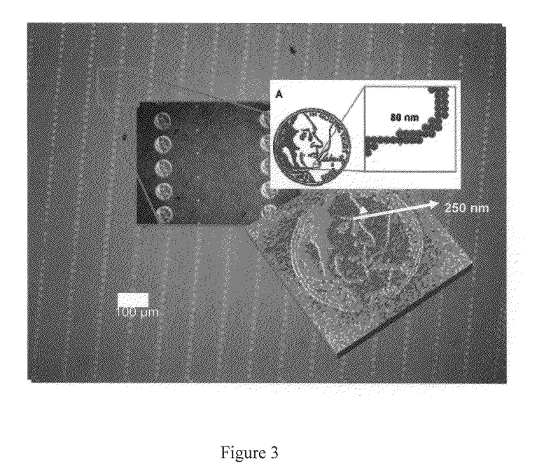

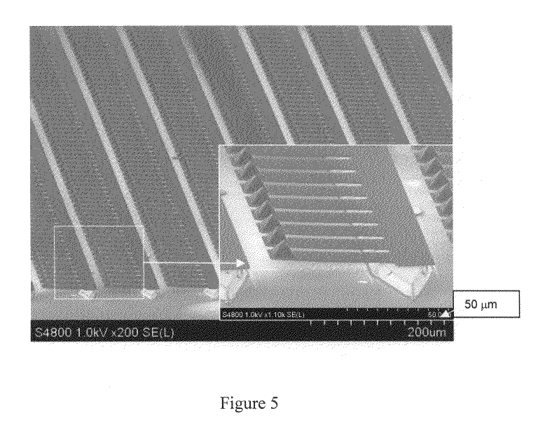

Two-dimensional pen arrays, including methods of making, are described in for example U.S. patent application Ser. No. 11/690,738 filed Mar. 27, 2007 to Mirkin et al. See also the present specification, FIGS. 3-5 for related devices and methods. See also Salaita et al., Angew. Chem. Int. Ed., 2006, 45, 7220-7223; Lenhert et al., Small, 2007, 3(1), 71-75, which are hereby incorporated by reference in their entirety.

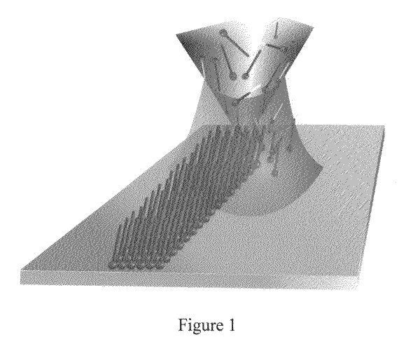

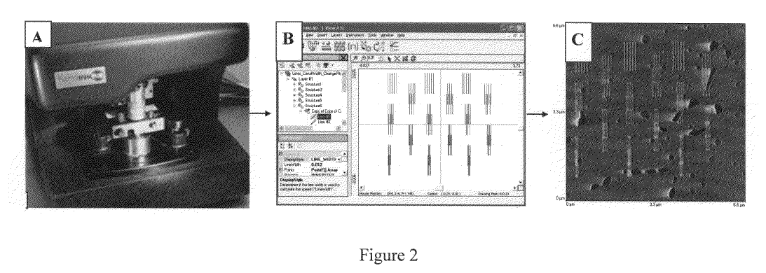

For practice of the various embodiments described herein, lithography, microlithography, and nanolithography instruments, pen arrays, active pens, passive pens, inks, patterning compounds, kits, ink delivery, software, and accessories for direct-write printing and patterning can be obtained from NanoInk, Inc., Chicago, Ill. Instrementation includes the NSCRIPTOR. Software includes INKCAD software (NanoInk, Chicago, Ill.), providing user interface for lithography design and control. E-Chamber can be used for environmental control. Dip Pen Nanolithography™ and DPN™ are trademarks of NanoInk, Inc. See FIGS. 1 and 2.

The following patents and co-pending applications related to direct-write printing with use of cantilevers, tips, and patterning compounds are hereby incorporated by reference in their entirety and can be used in the practice of the various embodiments described herein, including inks, patterning compounds, software, ink delivery devices, and the like:
1. U.S. Pat. No. 6,635,311 to Mirkin et al., which describes fundamental aspects of DPN printing including inks, tips, substrates, and other instrumentation parameters and patterning methods;
2. U.S. Pat. No. 6,827,979 to Mirkin et al., which further describes fundamental aspects of DPN printing including software control, etching procedures, nanoplotters, and complex and combinatorial array formation.
3. U.S. patent publication number 2002/0122873 A1 published Sep. 5, 2002 (“Nanolithography Methods and Products Produced Therefor and Produced Thereby”), which describes aperture embodiments and driving force embodiments of DPN printing.
4. U.S. regular patent application Ser. No. 10/366,717 to Eby et al., filed Feb. 14, 2003 (“Methods and Apparatus for Aligning Patterns on a Substrate”), which describes alignment methods for DPN printing (published Oct. 2, 2003 as 2003/0185967).
5. U.S. regular patent application Ser. No. 10/375,060 to Dupeyrat et al., filed Feb. 28, 2003 (“Nanolithographic Calibration Methods”), which describes calibration methods for DPN printing.
6. U.S. Patent Publication 2003/0068446, published Apr. 10, 2003 to Mirkin et al. (“Protein and Peptide Nanoarrays”), which describes nanoarrays of proteins and peptides;
7. U.S. Regular patent application Ser. No. 10/307,515 filed Dec. 2, 2002 to Mirkin et al. (“Direct-Write Nanolithographic Deposition of Nucleic Acids from Nanoscopic Tips”), which describes nucleic acid patterning (PCT/US2002/038252 published Jun. 12, 2003).
8. U.S. Regular patent application Ser. No. 10/320,721 filed Dec. 17, 2002 to Mirkin et al. (“Patterning of Solid State Features by Direct-Write Nanolithographic Printing”), which describes reactive patterning and sol gel inks (now published Aug. 28, 2003 as 2003/0162004).
9. U.S. Pat. Nos. 6,642,129 and 6,867,443 to Liu et al. (“Parallel, Individually Addressible Probes for Nanolithography”), describing active pen arrays.
10. U.S. Patent Publication 2003/0007242, published Jan. 9, 2003 to Schwartz (“Enhanced Scanning Probe Microscope and Nanolithographic Methods Using Same”).
11. U.S. Patent Publication 2003/0005755, published Jan. 9, 2003 to Schwartz (“Enhanced Scanning Probe Microscope”).
12. U.S. patent application Ser. No. 10/637,641 filed Aug. 11, 2003, now published as 2004/0101469, describing catalyst nanostructures and carbon nanotube applications.
13. U.S. patent application Ser. No. 10/444,061 filed May 23, 2003, now published as 2004/0026681 published Feb. 12, 2004, and US patent publication 2004/0008330 published Jan. 15, 2004, describing printing of proteins and conducting polymers respectively.
14. U.S. patent application Ser. No. 10/647,430 filed Aug. 26, 2003, now U.S. Pat. No. 7,005,378, describing conductive materials as patterning compounds.
15. U.S. patent application Ser. No. 10/689,547 filed Oct. 21, 2003, now published as 2004/0175631 on Sep. 9, 2004, describing mask applications including photomask repair.
16. U.S. patent application Ser. No. 10/705,776 filed Nov. 12, 2003, now published as 2005/0035983 on Feb. 17, 2005, describing microfluidics and ink delivery.
17. U.S. patent application Ser. No. 10/788,414 filed Mar. 1, 2004, now published as 2005/0009206 on Jan. 13, 2005 describing printing of peptides and proteins.
18. U.S. patent application Ser. No. 10/893,543 filed Jul. 19, 2004, now published as 2005/0272885 on Dec. 8, 2005, describing ROMP methods and combinatorial arrays.
19. U.S. patent application Ser. No. 11/056,391 filed Feb. 14, 2005, now published as 2005/0255237 published on Nov. 17, 2005, describing stamp tip or polymer coated tip applications.
20. U.S. patent application Ser. No. 11/065,694 filed Feb. 25, 2005, now published as 2005/0235869 on Oct. 27, 2005, describing tipless cantilevers and flat panel display applications.
21. US Patent publication 2006/001,4001 published Jan. 19, 2006 describing etching of nanostructures made by DPN methods.
22. WO 2004/105046 to Liu & Mirkin published Dec. 2, 2004 describes scanning probes for contact printing.
23. US Patent Application “Active Pen Nanolithography,” 11/268,740 to Shile et al. filed Nov. 8, 2005 describes for example thermcompression bonding and silicon handle wafers.

DPN methods are also described in Ginger et al., “The Evolution of Dip-Pen Nanolithography,” Angew. Chem. Int Ed 2004, 43, 30-45, including description of high-throughput parallel methods. See also Salaita et al., “Applications of Dip-Pen Nanolithography,” Nature Nanotechnology, 2007, Advanced On-line publication (11 pages).

Direct write methods, including DPN printing and pattern transfer methods, are described in for example Direct-Write Technologies, Sensors, Electronics, and Integrated Power Sources, Pique and Chrisey (Eds), 2002.

The direct-write nanolithography instruments and methods described herein are particularly of interest for use in preparing bioarrays, nanoarrays, and microarrays based on peptides, proteins, nucleic acids, DNA, RNA, viruses, biomolecules, and the like. See, for example, U.S. Pat. No. 6,787,313 for mass fabrication of chips and libraries; U.S. Pat. No. 5,443,791 for automated molecular biology laboratory with pipette tips; U.S. Pat. No. 5,981,733 for apparatus for the automated synthesis of molecular arrays in pharmaceutical applications. Combinatorial arrays can be prepared. See also, for example, U.S. Pat. Nos. 7,008,769; 6,573,369; and 6,998,228 to Henderson et al.

Scanning probe microscopy is reviewed in Bottomley, Anal. Chem., 1998, 70, 425R-475R. Also, scanning probe microscopes are known in the art including probe exchange mechanisms as described in, for example, U.S. Pat. No. 5,705,814 (Digital Instruments).

Microfabrication methods are described in for example Madou, Fundamentals of Microfabrication, 2^{nd} Ed., 2002, and also Van Zant, Microchip Fabrication, 5^{th} Ed., 2004.

### Support Structure

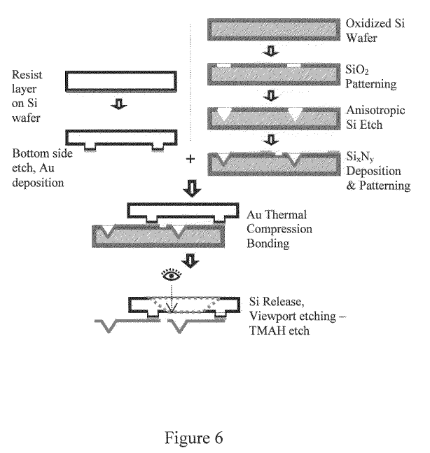

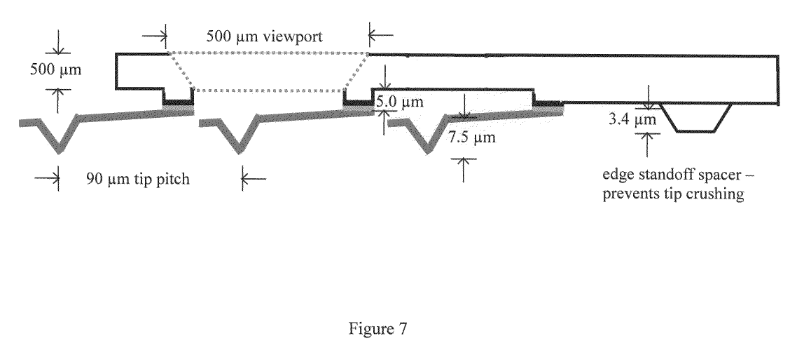

The support structure can be adapted to support cantilevers. For example, FIG. 6 illustrates one embodiment wherein a support structure is formed from a Si wafer using resist layer and bottom side etch with gold deposition. In another example, FIG. 7 illustrates a support structure adapted to support cantilevers. In addition, U.S. provisional application 60/792,950 filed Apr. 19, 2006 to Mirkin et al. describes support structures, which is hereby incorporated by reference in its entirety.

Particularly important design features include the heights of the silicon ridges and edge standoff spacers which help prevent crushing tips against the underside of the silicon handle wafer.

The support structure in many cases can be fabricated so that it is difficult to view the cantilevers without the presence of the viewports. For example, the support structure may be fabricated from a non-transparent material which does not allow viewing or fabricated from a material such as pyrex which might in principle be transparent but is scratched, or roughened or otherwise used in a way that does not allow viewing. The transparent material can become non-transparent through surface roughening and/or chemical etching, for example.

The support structure can be also described with use of the term “handle wafer.”

The support structure also can be adapted for coupling to a larger instrument. The coupling is not particularly limited but can be for example a mechanical coupling, or a magnetic coupling. A structure adapted for this coupling can be attached to the support structure. For example, a plastic clip adapted with magnetic material can be used.

The support structure can be fabricated from single crystal silicon. Advantage over pyrex for example includes etching holes through pyrex can be difficult or expensive or provide surface irregularities which interfere with bonding to cantilevers. Single crystal silicon provides for easier control of the etching.

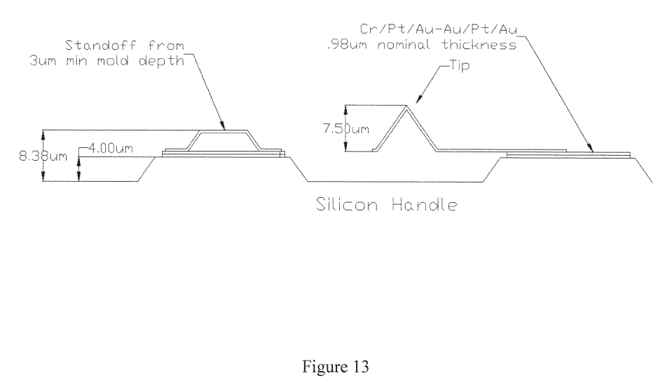

FIG. 13 illustrates an embodiment wherein the support structure further comprises standoff structure to help prevent mechanical damage to the cantilevers and tips.

The support structure can comprise base rows for supporting the cantilevers. Base row length is not particularly limited. For example, the base rows can have an average length of a. least about 1 mm. Average length for base row can be, for example, about 0.1 mm to about 5 mm, or about 0.5 mm to about 3 mm. In one embodiment, an array can be made which is about 1 cm by 1 cm and has a base row length of about 10 mm. If base row length becomes too long, one can be limited by bowing of support structure which can exceed the tip height and can keep all tips from touching the writing surface. Base row length can be adapted for each application to avoid this.

The base rows can have a height with respect to the support of at least about 5 microns. This height is not particularly limited but can be adapted for use with the appropriate cantilever bending. The height of the base row can be at or taller than the tip height minus the stop height to keep from crushing tips with overtravel.

The cantilevers can be supported on the base rows, and the base rows in turn can be supported on a larger support structure for the array. The base rows can extend from the larger support for the array. The array support can be characterized by a surface area which is about two square cm or less, or alternatively about 0.5 square cm to about 1.5 square cm. The size can be adjusted as needed for coupling with an instrument.

The support structure can comprises gold adapted to support or bond the two dimensional array of cantilevers to the support structure.

### 2D Array of Cantilevers

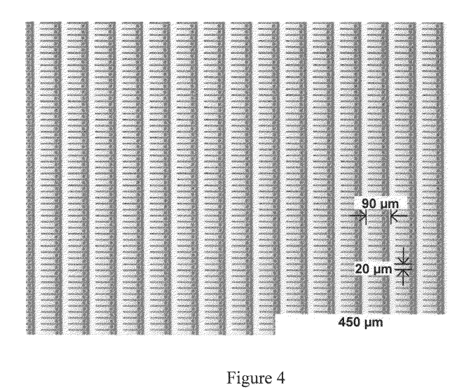

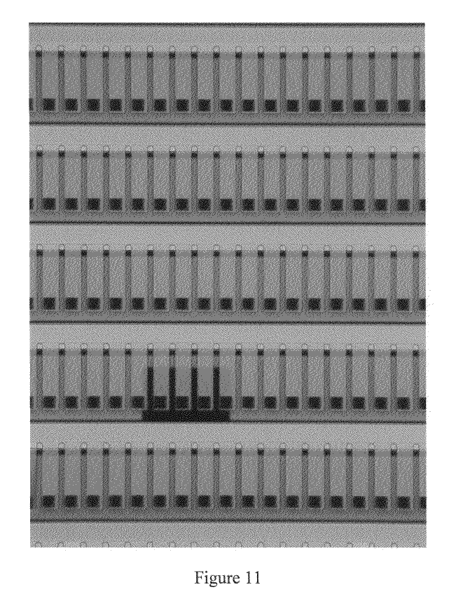

The 2D array of cantilevers are known in the art. For example, FIGS. 4, 5, 6, and 11 illustrate 2D arrays of cantilevers. In addition, for example, U.S. patent application Ser. No. 11/690,738 filed Mar. 27, 2007 to Mirkin et al., describes two dimensional arrays of cantilevers.

The two-dimensional array can be a series of rows and columns, providing length and width, preferably substantially perpendicular to each other. The arrays can comprise a first dimension and a second dimension. The two-dimensional array can be a series of one dimensional arrays disposed next to each other to build the second dimension. The two dimensions can be perpendicular. The cantilevers can comprise a free end and a bound end. The cantilevers can comprise tips at or near the free end, distal from the bound end. The cantilevers of one row can point in the same direction as the cantilevers on the next row, or the cantilevers of one row can point in the opposite direction as the cantilevers on the next row.

The two-dimensional arrays can be fabricated into a larger instrumental device by combining two parts, each part having a surface which is patterned in two dimensions and adapted to be mated with each other in the two dimensions. One part can comprise the support structure, without cantilevers, whereas the other part can comprise the cantilevers.

One important variable is the fraction or percentage of the cantilevers in the array which can actually function for the intended purposes. In some cases, some cantilevers can be imperfectly formed, or can be otherwise damaged after formation. A cantilever yield reflects this percentage of usable cantilevers. Preferably, the array is characterized by a cantilever yield of at least 75%, or at least 80%, or at least 90%, or at least 95%, or more preferably, at least about 98%, or more preferably at least 99%. In characterizing the cantilever yield, cantilevers at the ends of rows may be neglected which are damaged by processing of edges compared to internal cantilevers. For example, the central 75% can be measured. In many cases, the fabrication will be better done in the middle rather than the edge as edge effects are known in wafer fabrication. Defect density can increase in some cases as one moves from the center to the edge, or in other cases as one moves from edge to center. One can remove parts which have too high defect density and use remaining parts.

The array can be adapted to prevent substantial contact of non-tip components of the array when the tips are brought into contact with a substantially planar surface. For example, the cantilever arms should not contact the surface and can be accordingly adapted such as by, for example, bending. The tips can be adapted for this as well including, for example, long or tall tips. Factors which can be useful to achieve this result include use of long or tall tips, bending of the cantilever arms, tip leveling, row leveling, and leveling of the cantilevers in all dimensions. One or more combination of factors can be used.

The cantilever tips can be longer than usual in the art. For example, the tips can have an apex height relative to the cantilever of at least four microns on average, and if desired, the tips can have an apex height relative to the cantilever of at least seven microns on average. In addition, tip apex height can be at least 10 microns, or at least 15 microns, or at least 20 microns. No particular upper limit exists and technology known in the art and improving can be used. This long length can help ensure that only tips are contacting the surface. Apex height can be taken as an average of many tip apex heights, and in general, apex height is engineered not to vary substantially from tip to tip. Methods known in the art can be used to measure tip apex height including methods shown in the working examples.

In measuring parameters for the array, average measurements can be used. Average measurements can be obtained by methods known in the art including for example review of representative images or micrographs. The entire array does not need to be measured as that can be impractical.

Tipless cantilevers can be used in some embodiments, although not a preferred embodiment.

In addition, the cantilevers can be bent including bent towards the surface to be patterned. Methods known in the art can be used to induce bending. The cantilevers can be bent at an angle away from the base and the support. The cantilevers can comprise multiple layers adapted for bending of cantilevers. For example, differential thermal expansion or cantilever bimorph can be used to bend the cantilevers. Cantilever bending can be induced by using at least two different materials. Alternatively, the same materials can be used but with different stresses to provide cantilever bending. Another method is depositing on the cantilever comprising one material a second layer of the same material but with an intrinsic stress gradient. Alternatively, the surface of the cantilever can be oxidized. The cantilevers can be bent at an angle for example of at least 5° from their base, or at least 10° from their base, or at an angle of at least 15° from their base. Methods known in the art can be used to measure this including the methods demonstrated in the working examples. Average value for angle can be used. The cantilevers can be bent on average about 10 microns to about 50 microns, or about 15 microns to about 40 microns. This distance of bending can be measured by methods known in the art including the methods demonstrated in the working examples. Average distance can be used. The bending can result in greater tolerance to substrate roughness and morphology and tip misalignment within the array so that for example a misalignment of about ±20 microns or less or about ±10 microns or less can be compensated.

To facilitate bending, the cantilevers can comprise multiple layers such as two principle layers and optional adhesion layers and can be for example bimorph cantilevers. The cantilevers can be coated with metal or metal oxide on the tip side of the cantilever. The metal is not particularly limited as long as the metal or metal oxide is useful in helping to bend the cantilevers with heat. For example, the metal can be a noble metal such as gold.

In preferred embodiments, the array can be adapted so that the cantilevers are both bent toward the surface and also comprise tips which are longer than normal compared to tips used merely for imaging.

The tips can be fabricated and sharpened before use and can have an average radius of curvature of, for example, less than 100 nm. The average radius of curvature can be, for example, 10 nm to 100 nm, or 20 nm to 100 nm, or 30 nm to 90 nm. The shape of the tip can be varied including for example pyramidal, conical, wedge, and boxed. The tips can be hollow tips or contain an aperture including hollow tips and aperture tips formed through microfabrication with microfluidic channels passing to end of tip. Fluid materials can be stored at the end of the tips or flow through the tips.

The tip geometry can be varied and can be for example a solid tip or a hollow tip. WO 2005/115630 (PCT/US2005/014899) to Henderson et al. describes tip geometries for depositing materials onto surfaces which can be used herein.

The two dimensional array can be characterized by a tip spacing in each of the two dimensions (e.g., length dimension and width dimension). Tip spacing can be taken, for example, from the method of manufacturing the tip arrays or directly observed from the manufactured array. Tip spacing can be engineered to provide high density of tips and cantilevers. For example, tip density can be at least 10,000 per square inch, or at least 40,000 per square inch, or at least 70,000 per square inch, or at least 100,000 per square inch, or at least 250,000 per square inch, or at least 340,000 per square inch, or at least 500,000 per square inch. The array can be characterized by a tip spacing of less than 300 microns in a first dimension of the two dimensional array and less than 300 microns in a second dimension of the two dimensional array. To achieve even higher density, the tip spacing can be, for example, less than about 200 microns in one dimension and less than about 100 microns, or less than about 50 microns, in another dimension. Alternatively, the tip spacing can be for example less than 100 microns in one dimension and a less than 25 microns in a second direction. The array can be characterized by a tip spacing of 100 microns or less in at least one dimension of the two dimensional array. In one embodiment, tip spacing can be about 70 microns to about 110 microns in one dimension, and about 5 microns to about 35 microns in the second dimension. There is no particular lower limit on tip spacing as fabrication methods will allow more dense tip spacing over time. Examples of lower limits include 1 micron, or 5 microns, or 10 microns so for example tip spacings can be one micron to 300 microns, or one micron to 100 micron.

The number of cantilevers on the two dimensional array is not particularly limited but can be at least about three, at least about five, at least about 250, or at least about 1,000, or at least about 10,000, or at least about 50,000, or at least about 55,000, or at least about 100,000, or about 25,000 to about 75,000. The number can be increased to the amount allowed for a particular instrument and space constraints for patterning. A suitable balance can be achieved for a particular application weighing for example factors such as ease of fabrication, quality, and the particular density needs.

The tips can be engineered to have consistent spacing for touching the surface consistently. For example, each of the tips can be characterized by a distance D spanning the tip end to the support, and the tip array is characterized by an average distance D′ of the tip end to the support, and for at least 90% of the tips, D is within 50 microns of D′. In another embodiment, for at least 90% of the tips, D is within 10 microns of D′. The distance between the tip ends and the support can be for example about 10 microns to about 50 microns. This distance can comprise for example the additive combination of base row height, the distance of bending, and the tip height.

Cantilever force constant is not particularly limited. For example, the cantilevers can have an average force constant of about 0.001 N/m to about 10 N/m, or alternatively, an average force constant of about 0.05 N/m to about 1 N/m, or alternatively an average force constant of about 0.1 N/m to about 1 N/m, or about 0.1 N/m to about 0.6 N/m.

The cantilevers can be engineered so they are not adapted for feedback including force feedback. Alternatively, at least one cantilever can be adapted for feedback including force feedback. Or substantially all of the cantilevers can be adapted for feedback including force feedback. For example, over 90%, or over 95%, or over 99% of the cantilevers can be adapted for feedback including force feedback.

The cantilevers can be made from materials used in AFM probes including for example silicon, polycrystalline silicon, silicon nitride, or silicon rich nitride. The cantilevers can have a length, width, and height or thickness. The length can be for example about 10 microns to about 80 microns, or about 25 microns to about 65 microns. The width can be for example 5 microns to about 25 microns, or about 10 microns to about 20 microns. Thickness can be for example about 100 nm to about 700 nm, or about 250 nm to about 550 nm. Tipless cantilevers can be used in the arrays, the methods of making arrays, and the methods of using arrays.

Arrays can be adapted for passive pen or active pen use. Control of each tip can be carried out by piezoelectric, capactive, electrostatic, or thermoelectric actuation, for example.

The arrays can be adapted for integration of tip coating and ink delivery. For example, microfluidics can be used to control inking and coating of the tips. Tips can be dipped into devices or ink can be delivered directly through internal regions of the tip for hollow tip embodiments.

An important embodiment is that the cantilevers can be bonded to the support structure via gold thermocompression bonding. Important factors can be an inherent force independence of the lithographic process based on cantilever tip deposition and use of low k flexible cantilevers including silicon nitride cantilevers.

### Viewport

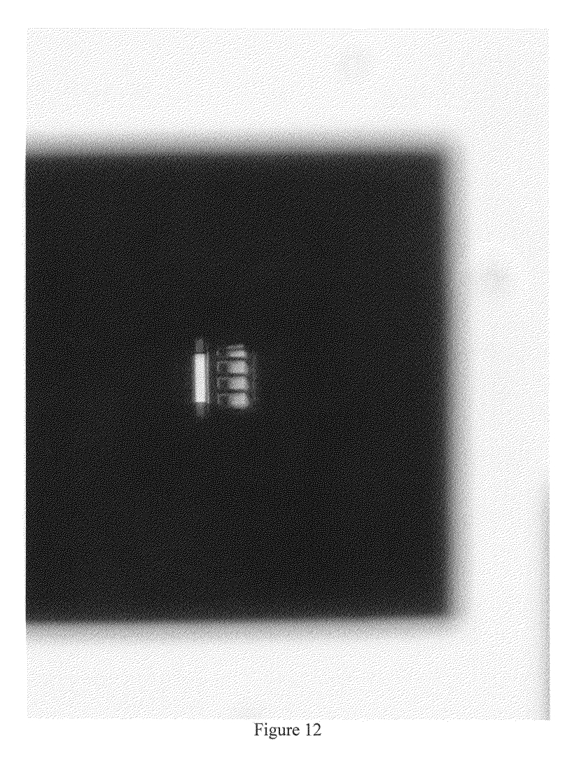

FIGS. 6, 7, and 12 illustrate a concept for the viewport or opening wherein the underlying cantilever can be viewed through the support structure through a viewport or an opening.

The viewport can be adapted to allow viewing. In turn, viewing can allow leveling. For example, depth, shape, length, and the width of the viewport can be adapted to allow viewing. If for example, a viewport were too long or too narrow, viewing may become more difficult or not possible. The viewport can be tapered which facilitates viewing or imaging the cantilevers from the opposite side. The top area of the viewport can be larger than the bottom area of the viewport. This can allow enough light to reach the substrate surface and cantilever to illuminate the contact point and reflect off the SiN cantilever, providing a color change which can be used to know when the tip or tips are touching the surface. The top of the opening can be wide enough so that blurring at the top is not an issue when focusing on the bottom.

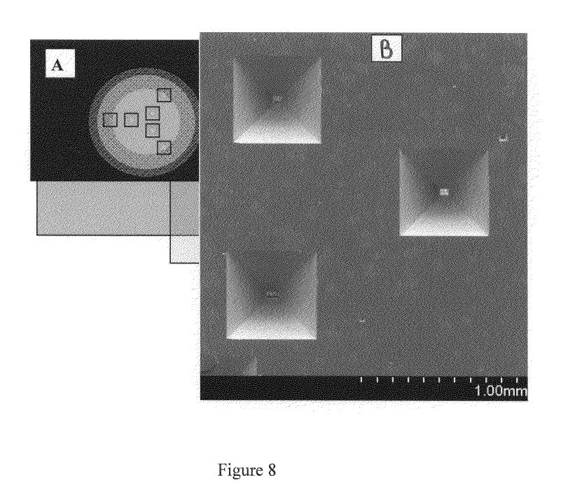

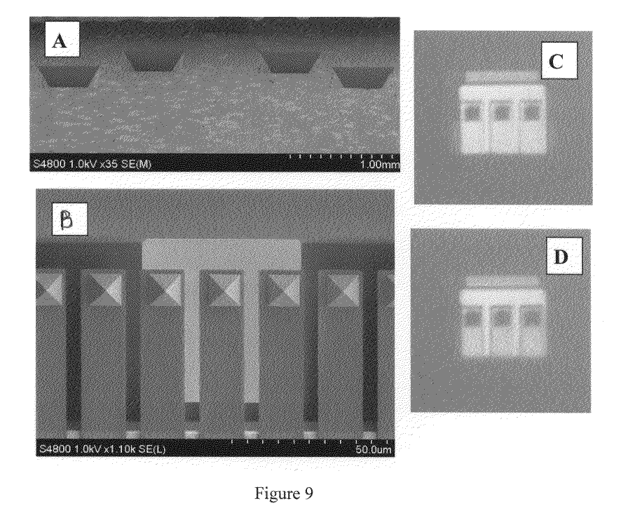

A plurality or cluster of viewports can be present, as illustrated in for example FIGS. 8 and 9. For example, the support structure can provide at least two, or at least three, or at least four, or at least five, or at least six viewports. The number of viewports can be adapted in view of the larger instrumental structure. For example, the number of viewports can be correlated with the number of motors used to level the cantilever array. For example, one could use at least one viewport per motor, or use two viewports per motor. For example, the six viewports in FIG. 8 are adapted to function with a three motor operation. To use the viewports, for example, one can adjust the cantilever array with a first motor and use a first viewport to review the result; then adjust the cantilever array with a second motor and use a second viewport to review the result; then adjust the cantilever array with a third motor and use a third viewport to review the result; and the like. One can cycle through the different motors and viewports iteratively until a desired leveling is achieved. One can execute first a more macroscopic type of leveling using the unaided eye if desired or possible followed by a more refined microscopic leveling. If desired and helpful, one can use an illuminated piece of paper behind the array in the horizontal plane of viewing. For example, an LED can be used for backlighting. One can also use a piezo-extension tool to verify leveling. Piezo-extension tools can be found for example in the Nscriptor instrument from NanoInk. It can provide for a manual extension and control of the z-piezo of an AFM type of scanner.

The plurality or cluster of viewports can be adapted and arranged to fit within the optical viewing area of a nanolithography instrument such as the NanoInk Nscriptor. The viewports can be arranged symmetrically about a central point including for example C2, C3, C4, C5, and C6 symmetry as desired. For example, C3 symmetry can be present as shown in FIG. 8 and one embodiment comprises at least six viewports arranged in C3 symmetry. The appearance of the cantilevers can change when they are in two different states: in contact with the surface versus above the surface (FIGS. 9C and 9D). The changes can be due to different reflection of light permitted by open viewports. Image recognition software can be used as needed to detect changes.

The viewports can comprise sloping walls (see for example FIG. 7). The sloping walls can be characterized by an angle of slope. For example, a slope angle can be determined by the etching of crystalline silicon (e.g, 54.7 degrees). The viewports can comprise a variety of shapes including for example a pyramidal shape.

The shape of the viewport is not particularly limited as long as it can be made and can allow for viewing. The size of the viewport can be varied for an application as needed. For example, a lateral dimension of the viewport at the first side (away from the cantilevers) such as width can be for example about one micron to about 1,000 microns, or about 250 microns to about 750 microns. The various sizes shown in FIG. 7, including viewpoint size, can be adjusted as needed and functionality is retained for example increased or decreased, by 5%, 10%, 15%, 20%, 25%, or even in some cases 50% or 100%. The viewport can be sufficiently small so that the structure is not destabilized. The viewport dimensions can be limited by the pitch of the ridges in one direction, but laterally can be unlimited in for example another direction.

Viewing through the viewport can be facilitated with optical devices such as a microscope. For example, microscopes can be used which are used in AFM and similar devices. The microscope can have for example a long working distance lens. The NanoInk Nscriptor lens can be for example a 10× objective lens. An onboard camera can be used with further zoom capability. The resulting video image can be for example about 300 microns×about 400 microns.

Another advantage of a viewport is that it can provide laser access which for example can allow laser feedback from the cantilevers.

One can use the viewports first to work in a sacrificial area of a substrate to for example perform leveling and surface checks and then later move to a patterning area.

### Methods of Making

Additional embodiments include methods of making. For example, one embodiment provides: (i) providing a first structure which comprises a support structure comprising a first side and a second opposing side, (ii) providing a second structure which comprises a two dimensional array of cantilevers, (iii) combining the first structure and the second structure, wherein the second structure is bonded to the second side of the first structure, and (iv) forming at least one viewport in the support structure so that cantilevers can be viewed from the first side of the support structure through the viewport.

Viewports can be formed by for example etching including chemical etching or deep reactive ion etching (DRIE). Etching of silicon can be carried out by for example tetramethyl ammonium hydroxide (TMAH) or potassium hydroxide (KOH). While drilling methods such as for example laser drilling may be used in some embodiments, laser drilling can provide holes which do not allow for a visualization of the cantilevers. The etching can be carefully controlled so that for example the viewport is large enough to allow seeing but the etching is not so long that etching interferes with structural supports for cantilevers. Accordingly, the etch time can be carefully monitored for a particular application.

A variety of methods can be used to attach or bond a structure comprising an array of cantilevers to the support structure or the handle wafer, particularly methods consistent with use of a silicon support structure, provide for contact which allows for electric current flow through the contact, and low temperature bonding. Bonding methods are described for example in Madou, Fundamentals of Microfabrication, 2^{nd} Ed., pages 484-494 and other pages which describes for example field-assisted thermal bonding, also known as anodic bonding, electrostatic bonding, or the Mallory process. Methods which provide low processing temperature can be used. For example, the cantilevers can be bound to the base by a non-adhesive bonding. Bonding examples include electrostatic bonding, field-assisted thermal bonding, silicon fusion bonding, thermal bonding with intermediate layers, eutectic bonding, gold diffusion bonding, gold thermocompression bonding, adhesive bonding, and glass frit bonding. Particularly important methods include gold thermocompression bonding, metal eutectic bonding, including gold-indium eutectic bonding, direct or indirect fusion bonding, or use of an adhesive such as for example BCB (benzocyclobutene).

In a preferred embodiment, provided is a method of fabrication of cantilevers using a (gold) thermocompression bond. During or before gold thermocompression bonding, a gold thin film is deposited on the probe wafer and the handle wafer, and then is patterned by etch or lift-off. The wafers are then aligned and heated to 300° C. or higher before being subjected to bond pressures in excess of for example 0.5 MPa or even in excess of 2 MPa. The following publications can be used to practice these embodiments with regards to gold-gold thermocompression: “Fabrication process and plasticity of gold-gold thermocompression bonds” C. H. Tsau et al. 6^{th} symposium on semiconductor wafer bonding: science, technology and applications, ECS proceedings (2001); “Characterization of low temperature, wafer-level gold-gold thermocompression bonds”, C. H. Tsau et al. Material Sciences of Micromechanical Systems Devices II/1999, P. de Boers et al., Eds. 605, p. 171-176 MRS symposium proceedings (2000); “Fabrication of wafer-level thermocompression bonds”, C. H. Tsau et al. J. Microelectromech. Sys. 11(6), 2002; “Design and fabrication of a THz nanoklystron” H. M. Manohara. P. H. Siegel et al. Report of the let Propulsion Lab (NASA) and CIT, Pasadena, Calif.

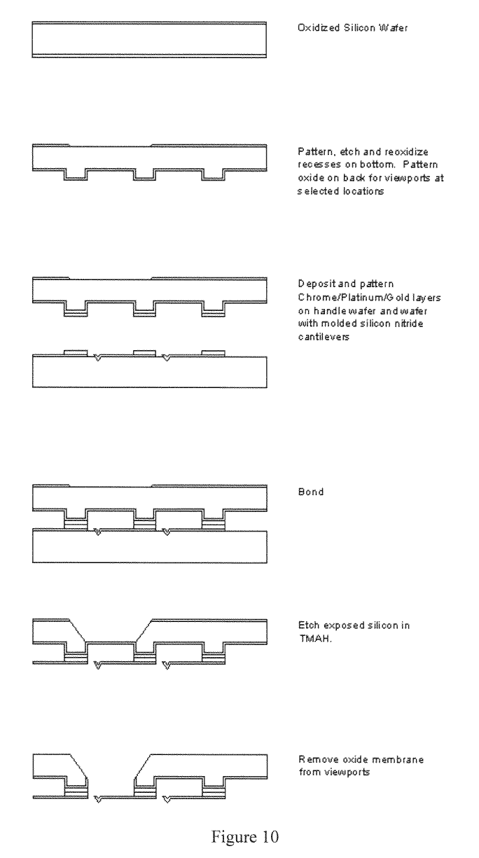

In one embodiment, FIG. 10 illustrates a method of making a device comprising support structure, cantilevers, and at least one viewport. In a first step, an oxidized silicon wafer is provided which will become a support structure with further processing. The wafer comprises a first side (upper) and a second side (lower) which oppose each other. In a second step, the silicon wafer is modified. The first surface is patterned for later use in etching viewports. The second surface is patterned, etched to form recesses, and reoxidized. In a third step, a support structure is adapted by depositing and patterning chrome, platinum, and/or gold layers. A structure comprising a two dimensional array of cantilevers is provided. In a fourth step, the support structure or handle wafer and the structure comprising cantilevers are bonded. In a fifth step, the bulk viewport is formed by etching through the silicon although an oxide membrane remains. In a sixth step, the oxide membrane can be removed to form the viewport which allows viewing through the support structure.

### Methods of Using, Devices, Applications

The devices and articles described herein can be used in nanolithography and instruments for same for building structures at the nanoscale, or alternatively, the microscale. For example, materials can be transferred from the tip to a substrate surface. In doing so, one or more leveling, calibration, and alignment steps can be carried out.

In an alternative embodiment, the methods and devices described herein can be used for imaging existing structures, not fabrication or building new structures. In another embodiment, both fabrication and imaging can be carried out. For example, structures can be fabricated and then imaged. For example, one or more tips may be adapted and used for fabrication, whereas one or more other tips may be adapted and used for imaging.

One embodiment provides for example a method comprising: (i) providing an instrument comprising at least one support structure comprising a first side and an opposing second side; a two dimensional array of cantilevers supported by the support structure on the second side; wherein the support structure comprises at least one viewport adapted to allow viewing of the cantilevers from the first side; (ii) providing at least some of the cantilevers with an ink composition; and (iii) transferring the ink composition from the tips to a substrate surface.

Another embodiment provides for example a method comprising: (i) providing an instrument comprising at least one support structure comprising a first side and an opposing second side; a two dimensional array of cantilevers supported by the support structure on the second side; wherein the support structure comprises at least one viewport adapted to allow viewing of the cantilevers from the first side; (ii) providing a structure that is to the imaged; and (iii) imaging the structure to be imaged with the instrument.

In particular, leveling methods are described for example in U.S. provisional application Ser. No. 60/841,210 filed Aug. 31, 2006 and U.S. regular application Ser. No. 11/848,211 filed Aug. 30, 2007 to Haaheim, or for example in U.S. provisional application Ser. No. 61/026,196 filed on Feb. 7, 2008 to Haaheim. In some embodiments, leveling can be sufficient that at least 60%, or at least 70%, or at least 80%, or at least 90% of the tips are touching the surface at the same time, or are not touching the surface at the same time. One can seek to have substantially all or all of the tips touching at the same time or not touching at the same time. Leveling can be carried out so that substantially all of the tips are touching the surface but none of the standoffs are touching. Leveling can also provide that one can retract the z-piezo about 10 microns and ensure that substantially none or none of the tips are touching. This can be achieved with a high degree of planar alignment. In one example of leveling, an angular tolerance can be about ±0.0225 in either direction (the angle between the plane of the surface and the plane of the tip array). This angle can be dictated by the freedom-of-travel of the tips, based on the tip height and standoff height. A z-motor can be moved sufficiently precisely about 25 microns in either direction without taking the array out of the level position.

The tips can be coated with a patterning compound or ink material. The coating is not particularly limited; the patterning compound or ink material can be disposed at the tip end. Patterning compounds and materials are known in the art of nanolithographic printing and include organic compounds and inorganic materials, chemicals, biological materials, non-reactive materials and reactive materials, molecular compounds and particles, nanoparticles, materials that form self assembled monolayers, soluble compounds, polymers, ceramics, metals, magnetic materials, metal oxides, main group elements, mixtures of compounds and materials, conducting polymers, biomolecules including nucleic acid materials, RNA, DNA, PNA, proteins and peptides, antibodies, enzymes, lipids, carbohydrates, and even organisms such as viruses. The references described in the INTRODUCTION section describe many patterning compounds which can be used. Sulfur-containing compounds including thiols and sulfides can be used.

The methods by which the tips can be coated can include for example solution dipping or vacuum evaporation, as well as the microfluidic methods noted above. See U.S. patent application Ser. No. 10/705,776 filed Nov. 12, 2003, now published as 2005/0035983 on Feb. 17, 2005.

One particularly important application for 2D arrays relates to arrays, microarrays, and nanoarrays comprising substrates and biomolecules on the substrates including proteins, peptides, cell adhesion complexes, enzymes, antibodies, antigens, viruses, nucleic acids, DNA, RNA, carbohydrates, sugars, lipids, and the like. Biomolecules generally include for example molecules having amino acids, or nucleic acids, and derivatives thereof. In particular, single particle biological applications are important, e.g., probing interactions involving single virus, spores, or cells. One can engineer the cell-substrate interface at sub-cellular resolution. One can examine cell adhesion, growth, motility, and differentiation with use of custom, molecularly designed substrates. One can examine drug effectiveness and drug delivery. Using 2D nanopatterning, the process is scalable and can cover large areas for statistical investigations of individual bioprocesses. In one embodiment, compounds can be arrayed such as thiol compounds ODT and MHA and used to create fibronectin arrays.

Another exemplary application is direct biomolecule patterning as described in for example Lenhert et al., Small, 2007, 3(1), 71-75. One can pattern lipids, phospholipids, and other components of biological structures such as biological membranes. For example, working with the phospholipid 1,2-dioleoyl-sn-glycero-3-phophocholine (DOPC), one can pattern complex features at a throughput of at least 3×10¹⁰ μm² per hour. Generally, phospholipids are an important component of biological membranes, and arrays of them can be used as cell-surface models. Hence, high resolution DPN patterning creates model systems capable of mimicking the structural complexity of biological membranes. (DOPC) can be used as a universal ink for noncovalent patterning on diverse substrates including silicon, glass, titanium, and hydrophobic polystyrene, with lateral resolution down to 100 nm.

Another important application is formation of nanostructures including metal or semiconductor nanostructures such as gold or silicon. Nanostructures can be made having at least one lateral dimension such as dot diameter or line width less than 1,000 nm, or less than 500 nm, or less than 300 nm, or less than 100 nm.

Another important application is templating wherein a surface is first patterned and then additional structures are disposed on or self-assembled on the patterns such as for example biological structures, proteins, antibodies, nucleic acid structures, DNA, or nanostructures such as nanowires, nanotubes, or carbon nanotubes. For example, see U.S. Pat. No. 7,182,996 to Hong et al. for nanowire deposition; U.S. patent application Ser. No. 11/633,095 filed Dec. 4, 2006 to Mirkin et al. for carbon nanotube deposition; and U.S. Patent Publication 2003/0068446, published Apr. 10, 2003 to Mirkin et al. (“Protein and Peptide Nanoarrays”, which describes nanoarrays of proteins and peptides.

Substrates can be made with massive numbers of micron-scale or nanometer-scale structures, or nanostructures, formed at massively fast rates. For example, one important parameter is the rate at which structures can be formed. Using methods described herein, structures can be formed at a rate of at least 100,000 per minute, or at least 1,000,000 structures per minute, and even further at least 2,000,000 structures per minute, and even further at least 3,000,000 structures per minute, and even further at least 4,000,000 structures per minute, and even further at least 5,000,000 structures per minute, and even further at least 10,000,000 structures per minute. For example, structures formed at fast rates can be dot features having a diameter of for example about 25 nm to about 500 nm, or about 50 nm to about 200 nm. The structures can be dots and circles, wherein the tip is not moved in the X-Y direction during deposition of the patterning compound.

Other rate parameters can be used. For example, direct-writing can be carried out at a rate of at least 1.0 meter/min, or at least 3.3 meters/min (for example, if the tips are moved at appropriate rates such as for example a rate of 1 um/s). Patterning can be executed at 10,000,000 square microns per hour. Rates can be in some cases determined by the rate of diffusion spreading for one pen with multiplication by the number of pens.

A preferred embodiment comprises a method for direct-write nanolithography comprising: directly writing nanostructures at a rate of at least 100,000 per minute, wherein the directly writing comprises contacting a tip having a patterning compound thereon with a substrate. The rate can be at least 1,000,000 per minute, or at least 4,000,000 per minute. The nanostructures can comprise dots, lines, or substantially complete circles. The nanostructures can comprise dots having diameter about 50 nm to about 1,000 nm. The nanostructures can be separated by a distance between about 50 nm and about 1,000 nm, or about 100 nm to about 750 nm.

Substrates can be coated and patterned with for example at least 25,000,000 structures, or at least 50,000,000 structures, or at least 75,000,000 structures, or at least 1,000,000 structures, or at least 500,000,000 million structures, or at least 1,000,000,000 structures.

An important aspect is that the pattern formed on the substrate substantially matches either (1) a pattern generated with software and made with tip motion, or (2) the pattern of the array when the tips are not moved over the surface.

An important embodiment comprises the elimination of a feedback system. This embodiment, having this eliminated, is a basic and novel feature.

The substrates for patterning can be single layer or multilayer. They can be solids including polymers, glasses, composites, silicon, mica, diamond, ceramics, metals, and various oxides and complex mixtures.

The ink-substrate combination can be selected to provide stable structures. Stability can be enhanced by use of covalent bonding or chemisorption, or electrostatic attraction.

Arrays can be formed of inorganic, organic, or biological materials including nanostructures such as viruses, proteins, carbon nanotubes, nanowires, dendrimers, fullerenes, and the like.

Combinatorial arrays can be formed. Each spot in the array can provide the same composition or a different composition compared to the next spot.

Vibration isolation tables can be used. Environmental chambers can be used including nebulizer, real-time sensors for temperature and humidity control, and heating and cooling fans. High resolution optics can be used. Independent three motor leveling can be used. Tip biasing can be used.

If AFM-like instrumentation is used, the mode can be contact mode, non-contact mode, or intermittent contact mode.

Additional applications and descriptions useful herein can be found in the following references, which are incorporated herein by reference.
1. Piner, R. D., et al. Science, 1999. 283: p. 661-663.
2. Hong, S. H. and C. A. Mirkin. Science, 2000. 288(5472): p. 1808-1811.
3. Ginger, D. S., H. Zhang, and C. A. Mirkin. Angew. Chem. Int. Ed., 2004. 43: p. 30-45.
4. Sheehan, P. E., et al. Appl. Phys. Lett., 2004. 85(9): p. 1589-1591.
5. Demers, L. M., et al. Angew. Chem. Int. Ed., 2001. 40(16): p. 3071-3073.
6. Zhang, H., S. W. Chung, and C. A. Mirkin. Nano Lett., 2003. 3(1): p. 43-45.
7. Haaheim, J., et al. Ultramicroscopy, 2005. 103: p. 117-132.
8. Hong, S. H., J. Zhu, and C. A. Mirkin. Langmuir, 1999. 15(23): p. 7897-7900.
9. Hong, S. H., J. Zhu, and C. A. Mirkin. Science, 1999. 286(5439): p. 523-525.
10. Lee, K. B., J. H. Lim, and C. A. Mirkin. J. Am. Chem. Soc., 2003. 125(19): p. 5588-5589.
11. Lee, K.-B., S. J. Park, and C. A. Mirkin. Science, 2002. 295: p. 1702-1705.
12. Wang, Y., et al. PNAS, 2006. 103(7): p. 2026-2031.
13. Vega, R. A., et al. Angew. Chem. Int. Ed., 2005. 44(37): p. 6013-6015.
14. Lee, K. B., et al. Nano Letters, 2004. 4(10): p. 1869-1872.
15. Salaita, K. S., et al. Angew. Chem. Int. Ed., 2006. 45: p. 7220-7223.
16. Lenhert, S., et al. Small, 2007. 3(1): p. 71-75.

### ADDITIONAL EMBODIMENTS

Because the 2D array is often imperfectly parallel (i.e., level) to the substrate, an important issue is how to achieve and verify uniform contacts of all of the tips without driving the corners of the array into the sample, which would lead to sample scratching, pattern distortion, and arraying fishtailing during lithography. The “levelness” (or “planarity”) of the 2D array with respect to the substrate can be described in terms of the relative z positions of three distinct points on the array as measured by z-axis motors via the different viewports, or as two relative angular difference measurements as measured by goiniometer motors (i.e., φ, θ). Descriptions of leveling methods can be found in for example in U.S. provisional application Ser. No. 61/026,196 filed on Feb. 7, 2008 to Haaheim.

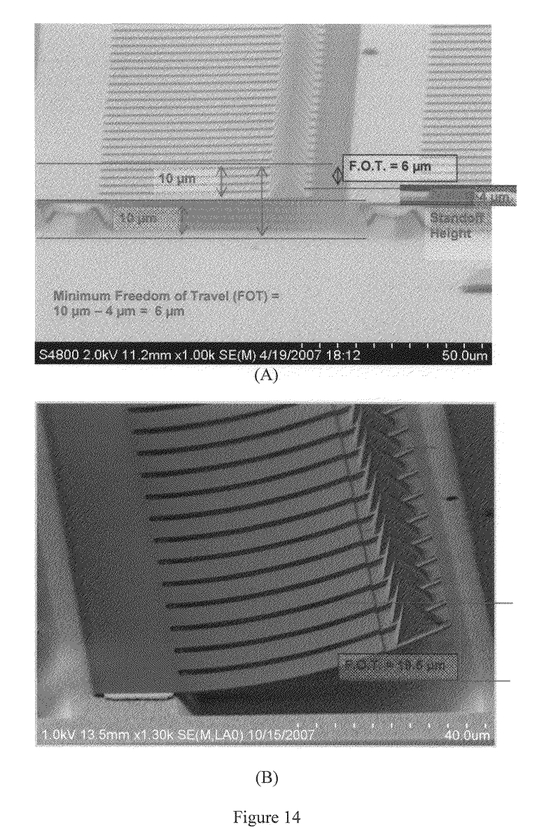

The concept of Freedom of Travel (F.O.T.) is particularly important in this process. F.O.T. provides an indicator of the tolerance level with respect to the standoffs where good lithography results can occur. For example, FIG. 14(A) illustrates one embodiment, wherein the array of cantilevers had a F.O.T. of 6 μm. Thus, in this embodiment, initial z-positioning of the cantilever tips between about 0.1 and about 5.9 μm within the F.O.T. can yield excellent lithography with uniform contact, while the extreme of about 0.0 μm can lead to no writing (i.e., no contact), and about 6.0 μm can lead to distorted writing (standoffs grounding out). In other words, in this embodiment, after making first contact (i.e., uniform contact) with the substrate, there was a 6.0 μm margin of error before grounding out on the standoffs. It is thus generally desirable to have a large F.O.T. Note that the F.O.T. of a cantilever can be limited in principle mostly by the length of the cantilever itself; for example, if the cantilever is perpendicular to the substrate, then F.O.T. is the length of the cantilever.

F.O.T. can be increased by introducing “curling” to the cantilevers, as illustrated in one embodiment as shown in FIG. 14(B). In this embodiment, the cantilevers curl upward, rendering a F.O.T. of 19.5 μm. Methods to increase F.O.T. include for example introducing at least one layer, or at least two layers, of stressed silicon nitride (“SiN”) onto each cantilever using methods known in the art. The stressed SiN can increase the F.O.T. via increasing the curling of cantilevers when one material wants to expand/contract relative to the other due to inherent stress. SiN can be deposited by chemical vapor deposition (CVD). In addition to increasing the F.O.T. of the cantilevers via increasing curling, the SiN layer(s) can allow fluorescent imaging to verify ink on the cantilevers. Fluorescent imaging is generally preferred to other imaging modalities, but it generally cannot be used in the presence of a metallic (e.g., gold) coating. Fluorescence gives one a large area view of biological process to which one can tag fluorophores, with about for example 1 to 2 micron spatial resolution. Fluorescence can also for example be indicative of bioactivity, e.g, whether biomaterial survived processing, because complementary biomaterial can be hybridized, and the complementary material can be fluorescently tagged. Other tagging methods (e.g., nanoparticle tagging) may involve cumbersome, time consuming, and subjective imaging methods such as for example AFM height scans.

Another method to increase F.O.T. can be to deepen the trenches between the cantilevers and reduce stiction. The deepening can be accomplished by for example etching including wet or dry etching. For example, pyrex can be subjected to dry etch and silicon to wet and dry etch. Alternatively, F.O.T. can be increased by reducing the height of the standoffs. Gold coating can be also used to reduce stiction.

In addition to increasing the tolerance level of the leveling process, an increase in F.O.T. can have an advantage of increasing the lithography yield. Note that several factors can contribute to an increase in yield. These factors include for example deepening of the trenches, roughening of the surface of the Si handle wafer, where rougher surfaces experience less stiction, and sharpening of the tips. The sharpening can, for example, introduce a ridge on the backside of the cantilever seen in FIG. 14b which can decrease the surface area available for stiction. In some embodiments, the yield was increased by for example at least 20%, at least 60%, or at least 100%. One advantage of oxide sharpened tips is that the dimensions of the features fabricated by lithography can be reduced. For example, in some embodiments, the dimensions were reduced by for example at least 20%, at least 50% or at least 80%. Tip sharpening effects are further described in Haaheim et al., Ultramicroscopy, 103 (2005) 117-132, which is hereby incorporated by reference in its entirety, including FIG. 8 and associated discussion.

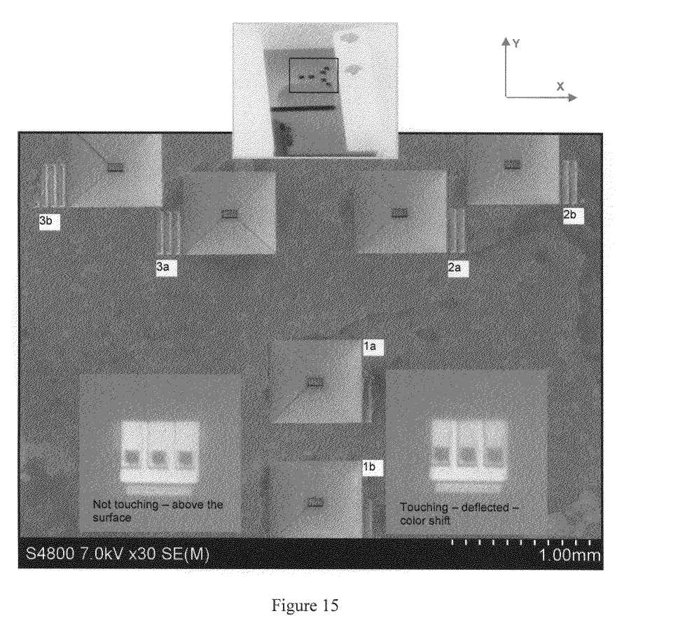

The leveling of the cantilevers can be further improved by, for example arranging the viewports in a desirable configuration. FIG. 15 provides illustration of one such embodiment. The viewports were arranged so that viewports 2a and 3a, 2b and 3b are aligned horizontally, respectively, to provide views of the same row(s) of cantilevers, thereby permitting vertical alignments of the cantilevers on the same row(s).

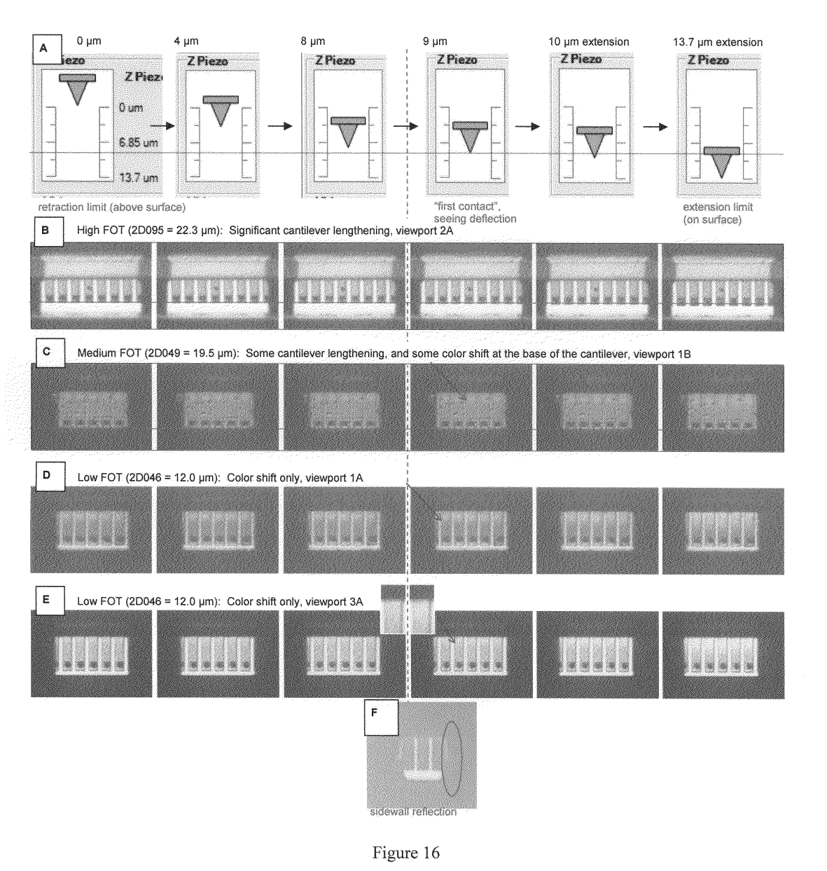

Additionally, increasing the size of each viewport can improve leveling. One advantage of enlarging the viewports is an increase in the number of cantilevers that can be viewed in one viewport. Another advantage is an increase in the light entering each viewport, thus allowing better viewing. A larger viewport can also provide better alignment between the laser and cantilevers during imaging. Another advantage of an increase in the size of the viewports includes improvement in the precision of deflection-based measurements of z-height. For example, deflection measurement precision can be increased from ±500 nm to ±100 nm. The size of the viewports can be increased by for example at least 30%, at least 70%, or 100%. For example, the viewport can be enlarged in width along the rows of cantilevers from 60 microns to 120 microns. The increase in light can provide better “end-point” detection, due to a more conspicuous change in color, alerting the operator that the cantilevers have been driven too far into the substrate. FIGS. 16 (A) through (F) provide illustrations of embodiments of arrays of cantilevers with different F.O.T., showing the color changes in the cantilevers as the cantilevers approached the substrate surface.

FIG. 16(A) illustrates the sequence of positions of the z-piezo used to bring the cantilevers seen in a given viewport into contact with the substrate surface.

FIG. 16(B) provides examples of the color change of the cantilevers that are highly curled with a large F.O.T. of 22.3 μm at different z-heights. Note that while the color change was not dramatic, the cantilevers noticeably lengthened as they contacted the surface and uncurled. The point of first lengthening was the point of first contact, between about 8.0 and about 9.0 μm.

FIG. 16(C) shows the color changes in the cantilevers slightly curled and with a F.O.T. of 19.5 μm. These cantilevers displayed both lengthening and a slight color change.

FIGS. 16(D) and (E) show cantilevers that were less curled with a F.O.T. of 12.0 μm, but displayed a dramatic color change across the entire length of each cantilever. At the point of first contact, the color at the base of the cantilevers displayed a subtle color change (see insets), but thereafter the changes became increasingly apparent as the z-piezo was repeatedly extended to 9.0 μm and retracted. The color shift became dramatic at an extension of 13.7 μm. Note that it was preferable to use the z-piezo tool to perform measurements because there was an about ±1 μm component backlash to the motion of any individual z-motor.

Sidewall reflection phenomena can occur when the cantilevers become sufficiently close to an aperture, giving rise to a mirror-like image (or reflection) on the sidewall of a viewport (see for example FIG. 16(F)). The reflection can be used to provide an indicator of whether the array of cantilever has been driven too far into the substrate. A description of the sloped sidewall is provided in the earlier VIEWPORT section.

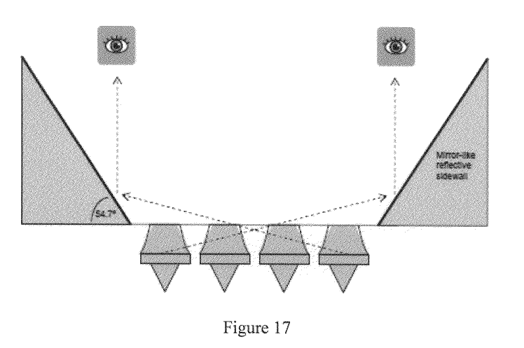

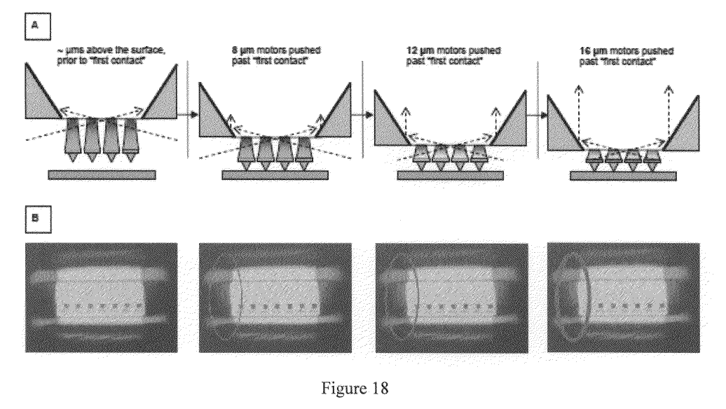

FIG. 17 provides a schematic of the sidewall reflection phenomena, demonstrating how the cantilevers reflect images of themselves on the viewport sidewalls when they became in close proximity with the viewport aperture. FIGS. 18 (A) and (B) illustrate that in one embodiment, the progression of sidewall deflection became increasingly overt as the cantilevers became deflected. Additionally, as the cantilevers with a high F.O.T. approached the aperture, they began to exhibit a color change that was comparable to the behavior of the cantilevers with a small F.O.T.

What is claimed:

1. An article comprising:
at least one support structure comprising a first side and an opposing second side,
a two dimensional array of cantilevers supported by the support structure on the second side,
wherein the support structure comprises at least one viewport adapted to allow viewing of the cantilevers from the first side.

2. An article according to claim 1, wherein the support structure comprises silicon.

3. An article according to claim 1, wherein the support structure is a silicon support structure.

4. An article according to claim 1, wherein the first side of the support structure comprises a surface having a surface area which is about two square cm or less.

5. An article according to claim 1, wherein the support structure comprises at least one edge standoff spacer.

6. An article according to claim 1, wherein the support structure comprises a plurality of base rows on the second surface which support the cantilevers.

7. An article according to claim 1, wherein the support structure comprises gold adapted to support the two dimensional array of cantilevers to the support structure.

8. An article according to claim 1, wherein the viewport is adapted to allow microscopic viewing of the cantilevers from the first side.

9. An article according to claim 1, wherein the support structure comprises at least three viewports adapted to allow viewing.

10. An article according to claim 1, wherein the support structure comprises at least six viewports adapted to allow viewing.

11. An article according to claim 1, wherein the support structure comprises at least six viewports arranged with C3 symmetry.

12. An article according to claim 1, wherein the viewport comprises sloping walls.

13. An article according to claim 1, wherein the viewport comprises sloping walls having an angle determined by etching crystalline silicon.

14. An article according to claim 1, wherein the viewport comprises a pyramidal shape.

15. An article according to claim 1, wherein the cantilevers comprise tips adapted for transferring materials from the tips to a substrate surface.

16. An article according to claim 1, wherein the cantilevers comprise tips adapted for AFM measurements.

17. An article according to claim 1, wherein the two dimensional array of cantilevers comprise at least 250 cantilevers.

18. An article according to claim 1, wherein the two dimensional array of cantilevers comprise at least 55,000 cantilevers.

19. An article according to claim 1, wherein the support structure is a silicon support structure, the two dimensional array of cantilevers comprises tips at the cantilever ends, and the support structure comprises at least three viewports.

20. An article according to claim 1, wherein the support structure is a silicon support structure, the two dimensional array of cantilevers comprises at least 55,000 cantilevers which comprise tips at the cantilever ends, and the support structure comprises at least three viewports which are adapted to allow microscopic viewing of the cantilevers from the first side.

21. An article comprising:
a two-dimensional array of a plurality of cantilevers, wherein the array comprises a plurality of base rows, each base row comprising a plurality of cantilevers extending from the base row, wherein each of the cantilevers comprise tips at the cantilever end away from the base row,
wherein the array is adapted to prevent substantial contact of non-tip components of the array when the tips are brought into contact with a substantially planar surface;
a support for the array, wherein the support comprises at least one viewport adapted to allow viewing of the cantilevers through the support.

22. An article according to claim 21, wherein the tips have an apex height relative to the cantilever of at least four microns.

23. An article according to claim 21, wherein the tips have an apex height relative to the cantilever of at least seven microns.

24. An article according to claim 21, wherein the cantilevers are bent at an angle away from the support.

25. An article according to claim 21, wherein the cantilevers are bent at an angle of at least 50 away from the support.

26. An article according to claim 21, wherein the tips have an apex height relative to the cantilever of at least four microns, and wherein the cantilevers are bent at an angle away from the support.

27. An article according to claim 21, wherein the tips have an apex height relative to the cantilever of at least seven microns, and wherein the cantilevers are bent at an angle of at least 100 away from the support.

28. An article according to claim 21, wherein the array is characterized by a tip spacing of less than 300 microns in a first dimension of the two dimensional array and less than 300 microns in a second dimension of the two dimensional array.

29. An article according to claim 21, wherein the array is characterized by a tip spacing of less than 200 microns in a first dimension of the two dimensional array and less than 50 microns in a second dimension of the two dimensional array.

30. An article according to claim 21, wherein the array is characterized by a tip spacing of 100 microns or less in at least one dimension of the two dimensional array.

31. An article according to claim 21, wherein the number of cantilevers is greater than 250.

32. An article according to claim 21, wherein the number of cantilevers is greater than 10,000.

33. An article according to claim 21, wherein the number of cantilevers is greater than 55,000.

34. An article according to claim 21, wherein each of the tips are characterized by a distance D spanning the tip end to the support, and the tip array is characterized by an average distance D′ of the tip end to the support, and for at least 90% of the tips, D is within 50 microns of D′.

35. An article according to claim 21, wherein each of the tips are characterized by a distance D spanning the tip end to the support, and the tip array is characterized by an average distance D′ of the tip end to the support, and for at least 90% of the tips, D is within 10 microns of D′.

36. An article according to claim 21, wherein the base rows have an average length of at least about 1 mm.

37. An article according to claim 21, wherein the cantilevers comprise multiple layers adapted for bending of cantilevers.

38. An article according to claim 21, wherein the cantilevers are bimorph cantilevers.

39. An article according to claim 21, wherein the cantilevers are not adapted for feedback.

40. An article according to claim 21, wherein at least one of the cantilevers is adapted for feedback.

41. An article according to claim 21, wherein substantially all of the cantilevers are adapted for feedback.

42. An article according to claim 21, wherein the base rows have a height with respect to the support of at least about 5 microns.

43. An article according to claim 21, wherein the tips have an average radius of curvature of less than 100 nm.

44. An article according to claim 21, wherein the tips have an average radius of curvature of about 10 nm to about 50 nm.

45. An article according to claim 21, wherein the cantilevers have an average force constant of about 0.001 N/m to about 10 N/m.

46. An article according to claim 21, wherein the cantilevers have an average force constant of about 0.05 N/m to about 1 N/m.

47. The article according to claim 21, wherein the array support is characterized by a surface on the far side away from the cantilever tips comprising a surface area which is about two square cm or less.

48. The article according to claim 21, wherein the array is characterized by a cantilever yield of at least 95%.

49. The article according to claim 21, wherein the array is characterized by a cantilever yield of at least 98%.

50. The article according to claim 21, wherein the cantilevers are bound to the base by a non-adhesive bonding.

51. An article according to claim 21, wherein the tips are coated with a patterning compound.

52. An article according to claim 21, wherein the cantilevers are bent on average about 10 microns to about 50 microns.

53. An article according to claim 21, wherein the tips have an apex height relative to the cantilever of at least four microns, and wherein the cantilevers are bent at an angle away from the support, and wherein the array is characterized by a tip spacing of less than 300 microns in a first dimension of the two dimensional array and less than 300 microns in a second dimension of the two dimensional array.

54. An article according to claim 21, wherein the tips have an apex height relative to the cantilever of at least seven microns, and wherein the cantilevers are bent at an angle of at least 100 away from the support, and wherein the array is characterized by a tip spacing of less than 300 microns in a first dimension of the two dimensional array and less than 300 microns in a second dimension of the two dimensional array.

55. An article according to claim 21, wherein the tips have an apex height relative to the cantilever of at least seven microns, and wherein the cantilevers are bent at an angle of at least 10° away from the support, and wherein the array is characterized by a tip spacing of less than 200 microns in a first dimension of the two dimensional array and less than 50 microns in a second dimension of the two dimensional array.

56. An article according to claim 21, wherein the number of cantilevers is greater than 250.

57. An article according to claim 21, wherein the number of cantilevers is greater than 10,000.

58. An article according to claim 21, wherein the cantilevers comprise multiple layers adapted for bending the cantilever.

59. The article according to claim 21, wherein the cantilevers are bound to the base by a non-adhesive bonding.

60. The article according to claim 21, wherein the support structure comprises at least three viewports.

61. A two-dimensional array of a plurality of cantilevers, the cantilevers comprising tips at the cantilever ends, wherein the array is adapted to prevent substantial contact of non-tip components of the array when the tips are brought into contact with a substantially planar surface, wherein the array is supported by a support structure which comprises at least one viewport for viewing the cantilevers.

62. The array according to claim 61, wherein the viewport is adapted to allow microscopic viewing of the cantilevers.

63. The array according to claim 61, the support structure comprising at least three viewports adapted to allow viewing.

64. The array according to claim 61, the support structure comprising at least six viewports adapted to allow viewing.

65. The array according to claim 61, the support structure comprising at least six viewports arranged with C3 symmetry.

66. The array according to claim 61, wherein the viewport comprises sloping walls.

67. The array according to claim 61, wherein the viewport comprises sloping walls having an angle determined by etching crystalline silicon.

68. The array according to claim 61, wherein the viewport comprises a pyramidal shape.

69. The array according to claim 61, wherein the viewport is sufficiently large to allow viewing but not so large as to interfere with support of cantilevers.

70. The array according to claim 61, wherein the array is combined with an instrument comprising at least three motors for positioning the array.

71. A method comprising:
(i) providing a first structure which comprises a support structure comprising a first side and a second opposing side;
(ii) providing a second structure which comprises a two dimensional array of cantilevers;
(iii) combining the first structure and the second structure, wherein the second structure is bonded to the second side of the first structure; and
(iv) forming at least one viewport in the support structure so that cantilevers can be viewed from the first side of the support structure through the viewport.

72. The method according to claim 71, wherein the bonding is thermocompression bonding.

73. The method according to claim 71, wherein first structure comprises gold, and the second structure comprises gold, and the first and second structures are bonded by a gold-gold bonding.

74. The method according to claim 71, wherein the forming step is an etching step.

75. the method according to claim 71, wherein the step of forming the viewport comprises etching silicon and further comprises etching silicon oxide membrane.

76. The method according to claim 71, wherein the support structure is a silicon support structure.

77. The method according to claim 71, wherein the second structure comprises at least 1,000 cantilevers.

78. The method according to claim 71, wherein the viewport is pyramidal shape.

79. The method according to claim 71, wherein the support structure comprises silicon, the bonding is thermocompression bonding, and the forming step is an etching step.

80. The method according to claim 79, wherein the second structure comprises at least 55,000 cantilevers.

81. A method comprising:
(i) providing an instrument comprising at least one support structure comprising a first side and an opposing second side; a two dimensional array of cantilevers supported by the support structure on the second side; wherein the cantilevers comprise tips, and wherein the support structure comprises at least one viewport adapted to allow viewing of the cantilevers from the first side;
(ii) providing at least some of the cantilever tips with an ink composition; and
(iii) transferring the ink composition from the tips to a substrate surface.

82. The method according to claim 81, wherein the ink composition comprises a biomolecule.

83. The method according to claim 81, wherein the ink composition comprises a nucleic acid repeat unit or an amino acid repeat unit, or a combination thereof.

84. The method according to claim 81, wherein the ink composition comprises a thiol.

85. The method according to claim 81, wherein after transfer of the ink, the substrate is further etched.

86. The method according to claim 81, wherein the cantilevers comprise tips for the ink composition.

87. The method according to claim 81, wherein the cantilevers comprise tips having a channel therethrough for ink flow.

88. The method according to claim 81, wherein the cantilevers comprise solid tips.

89. The method according to claim 81, wherein the cantilevers comprise AFM tips.

90. The method according to claim 81, wherein at least one leveling step is carried out with use of the viewport to level cantilevers with the substrate.

91. The method according to claim 81, wherein the cantilevers comprise tips, and at least one leveling step is carried out with use of the viewport to level cantilever tips with the substrate.

92. An instrument comprising the article according to claim 1.

93. An instrument comprising the article according to claim 21.

94. A method comprising:
(i) providing an instrument comprising at least one support structure comprising a first side and an opposing second side; a two dimensional array of cantilevers supported by the support structure on the second side; wherein the support structure comprises at least one viewport adapted to allow viewing of the cantilevers from the first side;
(ii) providing a structure which is to be imaged; and
(iii) imaging the structure to be imaged with the instrument.

95. A method comprising:
providing at least one array of cantilevers supported by at least one support structure;
providing a substrate;
providing a plurality of viewports in the support structure; and
leveling the at least one array of cantilevers with respect to the substrate with the plurality of viewports,
wherein the plurality of the viewports provide viewing of cantilevers.

96. The method according to claim 95, wherein the at least one array is a one dimensional or two dimensional array.

97. The method according to claim 95, wherein at least one of the cantilevers is coated with gold.

98. The method according to claim 95, wherein at least one of the cantilevers is coated with silicon nitride.

99. The method according to claim 95, wherein the cantilevers are tipless.

100. The method according to claim 95, wherein the cantilevers comprise tips.

101. The method according to claim 95, wherein the cantilevers comprise oxide sharpened tips.

102. The method according to claim 95, wherein the cantilevers comprise oxide sharpened tips with ridge to reduce surface area to reduce stiction, and wherein tip radius is less than 30 nm.

103. The method according to claim 95, wherein the substrate is flat.

104. The method according to claim 95, wherein the substrate not flat.

105. The article according to claim 1, wherein at least one of the array of the cantilevers is coated with silicon nitride.

106. The article according to claim 21, wherein at least one of the array of the cantilevers is coated with silicon nitride.

107. The article according to claim 1, wherein the two dimensional array of cantilevers comprises at least one row of cantilevers, and wherein the support structure comprises at least two viewports which allow viewing of cantilevers in the row of cantilevers.

108. The article according to claim 1, wherein the viewport is adapted to allow a side wall reflection of cantilevers.

109. The article of claim 1, wherein the viewport is at least 120 microns wide.

110. The article of claim 1, wherein the support structure comprises a plurality of trenches on the second side which are subjected to a trench deepening step to reduce cantilever stiction and increase cantilever freedom of travel.
